(19) United States
(12) Patent Application Publication
(10) Pub. No.: US 2007/0050314 A1
(43) Pub. Date: Mar. 1, 2007

(54) System and method for managing postage funds for use by multiple postage meters

(76) Inventors: Murray D. Martin, Ridgefield, CT (US); Andrei Obrea, Seymour, CT (US); David G. Collings, Shelton, CT (US)

Correspondence Address: PITNEY BOWES INC.;35 WATERVIEW DRIVE, P.O. BOX 3000, MSC 26-22, SHELTON, CT, 06484-8000, US

(21) Appl. No.: 11/216,557

(22) Filed: Aug. 31, 2005

(51) Int. Cl. G06F 17/00

(52) U.S. Cl. 705/403

(57) ABSTRACT

A system for managing postage funds that includes a data center computer system for authorizing and accounting for postage fund downloads for one or more customers, a customer funds repository in electronic communication with the data center computer system, and a plurality of postage meters located at a customer site remote from the data center computer system. The postage meters may selectively request and receive or return postage funds that have been previously downloaded to the customer funds repository from the data center computer system. Also, a method of securely transferring a first amount of postage funds from a first postage meter to a second postage meter in a side load transaction.

### FIELD OF THE INVENTION

The present invention relates to the downloading of postage funds to postage meters, and in particular to systems and methods for managing postage funds for use by multiple postage meters located at a customer site.

### BACKGROUND OF THE INVENTION

As is known in the art, postage meters, such as conventional analog or digital postage meters, are able to request and receive postage fund downloads (refills) from a remotely located computer data center. Many customers have more than one postage meter at a given location. For example, medium to large mailrooms often have more than one postage meter. Such customers find in many instances that one of the meters runs out of funds while the other meter or meters have plenty of funds available. Due to current postal authority regulations, current meters do not allow for the transfer of funds between postage meters, even when they belong to the same customer. As a result, customers cannot simply move funds from one meter to another when one meter runs out of funds. Instead, customers in such circumstances must endure the time and expense associated with refilling the empty potage meter directly from the data center. This problem is exacerbated in a production mail environment in which postage meters dispense postage at a high rate. In such an environment, there is a risk that single meters will run out of postage even more frequently than in the mailroom environment.

In addition, in either the mailroom or production mail environment, the data center may not be available at all times due to various reasons, such as scheduled or unscheduled maintenance or network problems. In current systems, meters cannot be refilled when the data center is not available. Thus, existing solutions require very good estimations of funds usage for each postage meter to minimize the number of refills and the amounts kept unused in postage meters.

Thus, there is a need for a system that allows postage funds used by multiple postage meters to be managed better such that funds are available as needed, regardless of the availability of the data center and such that downloads from the data center are minimized.

### SUMMARY OF THE INVENTION

The present invention provides a system for managing postage funds that includes a data center computer system for authorizing and accounting for postage fund downloads for one or more customers, a customer funds repository (CFR) in electronic communication with the data center computer system, and a plurality of postage meters located at one or more customer sites remote from the data center computer system. The customer fund repository is adapted to send a request for a first amount of postage funds to the data center computer system and to receive and store the first amount of postage funds downloaded from the data center computer system. The postage meters are in electronic communication with the customer funds repository. Each of the postage meters is adapted to selectively send a request for a second amount of postage funds to the customer funds repository and to receive and store the second amount of postage funds downloaded from the customer funds repository.

In one embodiment, the customer funds repository and the data center computer system are provided at a data center location remote from the customer site. In another embodiment, the customer funds repository is provided at the customer site.

Preferably, the data center computer system and the customer funds repository each store a first set of one or more keys that is used to securely send the request for a first amount of postage funds to the data center computer system and to securely download the first amount of postage funds from the data center computer system. In addition, each of the postage meters preferably stores a second set of one or more keys, wherein the customer funds repository stores the second set of one or more keys of each of the postage meters. For each one of the postage meters, the second set of one or more keys of the postage meter is used to securely send the request for a second amount of postage funds to the customer funds repository and to securely download the second amount of postage funds from the customer funds repository to the postage meter.

Another aspect of the invention provides a method of transferring a first amount of postage funds from a first postage meter to a second postage meter, referred to as a side load transaction. The method includes establishing a secure communications channel between the first postage meter and the second postage meter and causing the first postage meter to generate a message, such as a postal indicium (using an unused ZIP code) in an amount equal to the first amount of postage funds, that confirms that one or more registers of the first postage meter have been adjusted to reflect that the first amount of postage funds has been removed. The method further includes sending the message to the second postage meter through the secure communications channel and causing the second postage meter to load the first amount of postage funds.

The method may further include determining whether the message can be validated, wherein the step of causing the second postage meter to load the first amount of postage funds is performed only if the message can be validated. The method may also further include determining whether one or more business rules governing a transfer of postage funds from the first postage meter to the second postage meter are satisfied, wherein the step of causing the second postage meter to load the first amount of postage funds is performed only if the one or more business rules are determined to be satisfied. The one or more business rules may relate to one or more of a maximum amount of postage funds that may be transferred from the first postage meter to the second postage meter, a maximum number of times that postage funds may be transferred from the first postage meter to the second postage meter, and a time period during which postage funds may be transferred from the first postage meter to the second postage meter.

Moreover, before postage funds may be transferred in a side load transaction, a setup process is preferably performed. The setup process includes causing the first postage meter to connect to a data center over a second secure communications channel and the second postage meter to connect to the data center over a third secure communications channel, providing first information to the first postage meter over the second secure communications channel, and providing second information to the second postage meter over the third secure communications channel. The first information enables the first postage meter to authenticate the second postage meter and the second information enables the second postage meter to authenticate the first postage meter. The business rules may also be provided to each meter at this time.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a system for managing postage funds for use by multiple postage meters located at a customer site according to one embodiment of the present invention;

FIG. 2 is a flowchart showing a method by which postage funds may be downloaded to the customer funds repository of the system shown in FIG. 1 from the data center server computer of the system shown in FIG. 1 according to the present invention;

FIG. 3 is a flowchart showing a method by which the postage funds stored by the customer funds repository may be downloaded to a selected one of the postage meters according to a further aspect of the present invention;

FIG. 4 is a block diagram of a system for managing postage funds for use by multiple postage meters located at a customer site according to an alternative embodiment of the present invention;

FIG. 5 is a block diagram of a system for managing postage funds for use by multiple postage meters located at a customer site according to an alternative embodiment of the present invention in which postage funds may be directly and securely transferred between the postage meters;

FIG. 6 is a flowchart of a setup process according to the present invention that must be performed before a side load transaction between two postage meters may take place; and

FIG. 7 is a flowchart showing a method for conducting side load transactions between two postage meters.

FIG. 8 is a flowchart showing a method by which the postage funds stored by a postage meter 20 may be uploaded to CFR 50 according to another embodiment.

### DESCRIPTION OF THE PREFERRED EMBODIMENTS

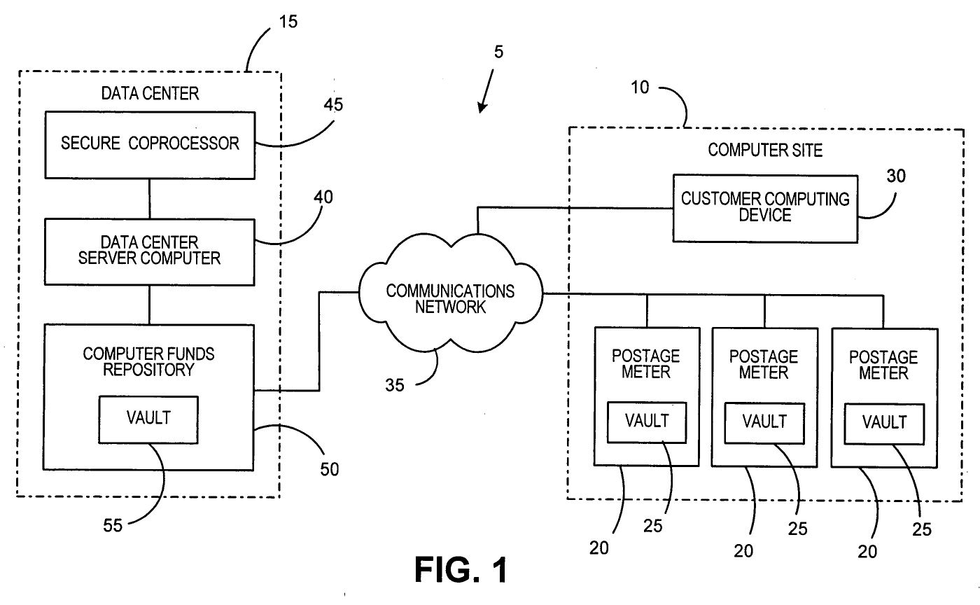

FIG. 1 is a block diagram of a system 5 for managing postage funds for use by multiple postage meters located at a customer site according to one embodiment of the present invention. The system 5 includes a customer site 10 and a data center 15 located remotely from the customer site 10. A plurality of postage meters 20 is located at the customer site 10. The customer site 10 may be, for example, a medium or large sized mailroom of a business entity or may be a production mail environment in which large mailings are prepared. Each postage meter 20 includes a vault 25 for securely storing postage funds and cryptographic keys that are used for requesting postage fund downloads as described herein. As is known, each vault 25 may, for example, be a crypto-card such as a FIPS 140-2 level 3 crypto-card, an example of which is the PCI IBM crypto-card or any other appropriate secure device. Also provided at customer site 10 is a computing device 30, such as a PC or an electronic device such as a PDA, the function of which will be described below. The computing device 30 and each of the postage meters 20 are in electronic communication with communications network 35, which may be the Internet or some other suitable network or combination of networks, to enable communication with the data center 15.

The data center 15 includes a data center server computer 40, which may be any type of know server computer or other suitable computing device, that is in electronic communication with a secure coprocessor 45. Together, the data center server computer 40 and the secure coprocessor 45 form part of a data center computer system. As is known in the art, secure coprocessor 45 stores cryptographic keys and associated cryptographic algorithms (which are executed by the secure coprocessor 45) for encrypting and/or digitally signing data. Data center 15 also includes a customer funds repository (CFR) 50 that is in electronic communication with both the data center server computer 40 and the communications network 35. Preferably, the customer funds repository 50 comprises a computing device, such as a PC or the like, that runs one or more software routines for executing the methods described herein.

According to an aspect of the present invention, the customer funds repository 50 stores postage funds downloaded from data center server computer 40, which funds may be subsequently requested by and selectively downloaded to each of the postage meters 20 located at the customer site 10. The customer funds repository 50 includes a vault 55, similar to vaults 25 of the postage meters 20, for storing the postage funds downloaded from the data center server computer 40 and the cryptographic keys used by the customer funds repository 50 according to the present invention as described elsewhere herein.

In the embodiment shown in FIG. 1, each vault 25 of each postage meter 20 includes a unique meter encryption key, a unique meter signing key. In addition, each vault 25 stores decryption keys necessary to authenticate and decrypt messages from the data center and CFR. The secure coprocessor 45 stores cryptographic keys for authenticating and decrypting messages received from individual postage meters 20. In prior art systems, those keys may be used by the postage meters 20 to encrypt and digitally sign requests for the download of postage funds that would then be securely sent to the data center server computer 40. The data center server computer 40 would then in turn use those keys to authenticate the requests for the download of postage funds and to encrypt and digitally sign the postage funds data that is sent to each postage meter 20. By contrast, as described in greater detail below, in the present invention those keys are used by the customer funds repository 50 to authenticate requests for the download of postage funds received from the postage meters 20 and to encrypt and digitally sign postage funds data that is sent from the customer funds repository 50 to each postage meter 20.

According to the present invention, the secure coprocessor 45 and the customer funds repository 50 (in particular the vault 55) are further provided with appropriate cryptographic keys that allow them to securely communicate with and authenticate one another. Such keys may comprise one or more public/private key pairs, wherein public (asymmetric) key cryptography techniques are employed, or one or more secret keys, such as a CFR encryption key and a CFR signing key, wherein secret (symmetric) key cryptography techniques are employed. In many cases, it is practical to use combinations of public/private key pairs and symmetric keys. In addition, during an initialization procedure, the customer funds repository 50 receives from the data center server computer 40 all of the keys that are necessary for the customer funds repository 50 to securely communicate with and provide postage funds to the postage meters 20 such that the customer funds repository 50 can act as a source of postage funds for the postage meters 20 present at the customer site 10. In the particular embodiment shown in FIG. 1, those keys would be the unique meter encryption key and the unique meter signing key of each postage meter 20. The keys may also include an update key used to encrypt updates to these keys. The keys received from the data center 40 are stored in the vault 55 of the customer funds repository 50.

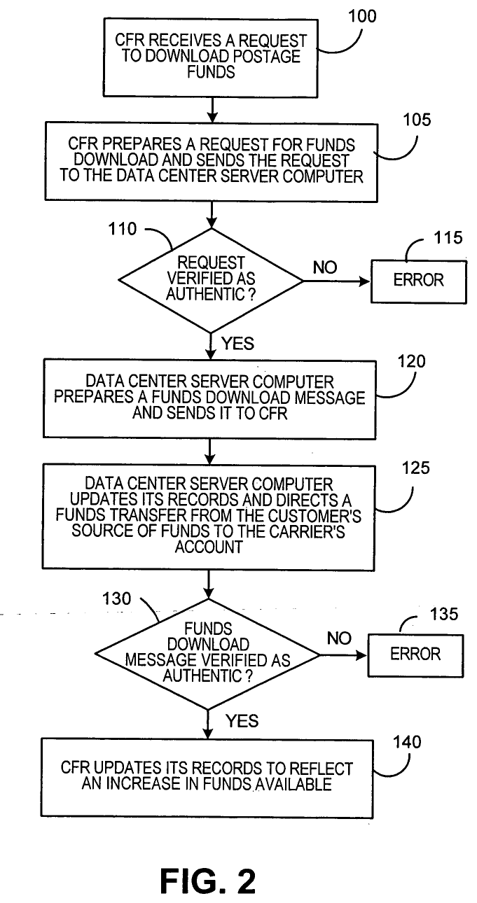

FIG. 2 is a flowchart showing a method by which postage funds may be downloaded to the customer funds repository 50 from the data center server computer 40 according to an aspect of the present invention so that those funds may later be selectively downloaded to one or more of the postage meters 20 for use thereby. The method begins at step 100, where the customer funds repository (CFR) 50 receives a request asking it to download a certain amount of postage funds for storage thereby. In the embodiment shown in FIG. 1, this request comes from one of the postage meters 20, and is sent to the customer funds repository 50 over communications network 35. Alternatively, the request may come from the customer computer device 30 (in response to input from the customer). Next, at step 105, the customer funds repository 50 prepares a request for funds download (in the amount specified in the request received in step 100) and sends the request for funds download to the data center server computer 40. Preferably, the request is encrypted and digitally signed. In the particular embodiment shown in FIG. 1, the request is encrypted using the CFR encryption key and signed using the CFR signing key. At step 110, once the data center server computer 40 receives the request for funds download, it, in conjunction with the secure coprocessor 45, determines whether the request for funds download is correct (verifies authenticity and integrity of the message). In particular, the secure coprocessor, which stores the CFR encryption key and the CFR signing key, uses those keys to decrypt the request for funds download and verify the digital signature of the request for funds download.

If the request for funds download cannot be verified as being authentic, then an error condition is detected as shown in step 115 such that the request for funds download cannot be fulfilled. If, however, the request for funds download can be successfully verified as being authentic, then, at step 120, the data center server computer 40 prepares a funds download message and sends it to the customer funds repository 50. The funds download message includes data representing postage funds equal to the amount requested in step 100. Preferably, the funds download message is encrypted and digitally signed. In the particular embodiment shown in FIG. 1, the funds download message is encrypted using the CFR encryption key and signed using the CFR signing key by the secure coprocessor 45. Then, at step 125, the data center server computer 40 updates its records to reflect that the customer associated with customer site 10 has purchased the postage funds that were downloaded to the customer funds repository 50. Typically, this involves directing a funds transfer from the customer's source of payment funds (e.g., a credit card) to the account of the postal carrier in question (e.g., the USPS).

At step 130, the customer funds repository 50 determines whether the funds download message is authentic. In the particular embodiment shown in FIG. 1, the customer funds repository 50 uses the CFR encryption key and the CFR signing key to decrypt the funds download message and verify the digital signature of the funds download message. If the funds download message cannot be verified as being authentic, then an error condition is detected as shown in step 135 such that the funds associated with the funds download message cannot be used by the customer funds repository 50. If, however, the funds download message can be successfully verified as being authentic, then, at step 140, the customer funds repository 50 updates its records to reflect an increase in postage funds that are available for use by the postage meters 20. In particular, the data representing the postage funds that is contained in the funds download message is stored in the vault 55 of the customer funds repository. Thus, as will be appreciated, after the steps shown in FIG. 2 are completed, the customer funds repository 50 will store an amount of postage funds that may be selectively downloaded to one or more of the postage meters 20 for use in applying evidence of postage payment (a postal indicium) to items to be mailed. In this sense, the customer funds repository 50 functions much like a postage meter downloading postage funds in known prior art postage download systems.

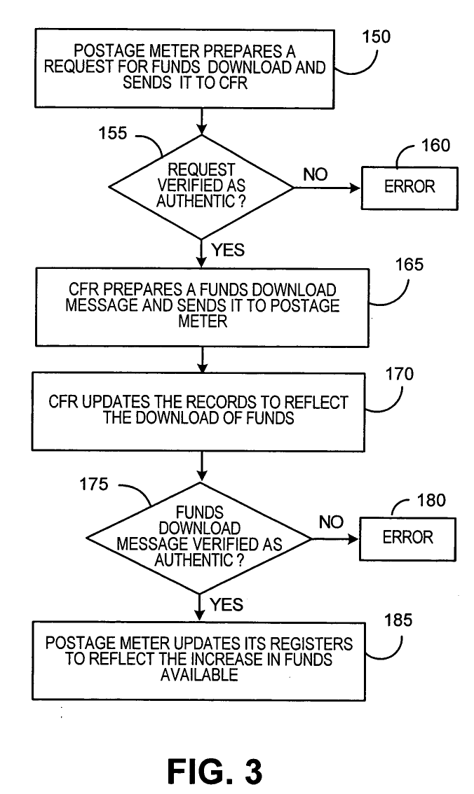

FIG. 3 is a flowchart showing a method by which the postage funds stored by the customer funds repository 50 may be downloaded to a selected one of the postage meters 20 according to a further aspect of the present invention so that those funds may used by that postage meter 20 to apply evidence of postage payment to items to be mailed. The method begins at step 150, where the postage meter 20 prepares a request for funds download (for a particular amount of postage) and sends it to the customer funds repository 50 over communications network 35. Preferably, the request for funds download is encrypted for security purposes. In the particular embodiment shown in FIG. 1, the request for funds download is encrypted using the unique meter encryption key for the postage meter 20 in question and digitally signed using the unique meter signing key for the postage meter 20 in question.

Once the request for funds download is received by the customer funds repository 50, it then, as shown in step 155, determines whether the request for funds download can be verified as being authentic. In the embodiment of FIG. 1, the customer funds repository does so by decrypting the request for funds download using the unique meter encryption key for the postage meter 20 in question that is stored in the vault 55 and verifying the digital signature using the unique meter signing key for the postage meter 20 in question that is stored in the vault 55. If the answer at step 155 is no, then an error condition is detected and the request will not be fulfilled. If, however, the answer at step 155 is yes, then the customer funds repository 50 accesses the postage fund data from the vault 55, prepares a funds download message including data representing the requested amount of postage (if the full amount is available), and sends the funds download message to the postage meter 20 in question over the communications network 35. Preferably, the funds download message is encrypted and digitally singed for security purposes. In the particular embodiment of FIG. 1, the funds download message is encrypted using the unique meter encryption key for the postage meter 20 in question and digitally signed using the unique meter signing key for the postage meter 20 in question. Next, at step 170, the customer funds repository 50 updates its records (the data stored in vault 55) to reflect the amount of postage funds that were downloaded.

At step 175, the postage meter 20 then determines whether the funds download message can be verified as being authentic. In the particular embodiment of FIG. 1, the postage meter 20 does this by decrypting the funds download message using its unique meter encryption key and verifies the digital signature using its unique meter signing key. If the answer at step 175 is no, then an error condition is detected, and the postage meter 20 will not accept and store the download of funds. If the answer at step 175 is yes, then, at step 185, the postage meter 20 updates its registers (in its vault 25) to reflect the increase in postage funds that are available for use in printing evidence of postage payment on items to be mailed. Thus, as will be appreciated, using the method of FIG. 3, a postage meter 20 is able to readily download postage funds as needed from the customer funds repository 50 without having to go through all of the formal steps required in prior art systems to download postage from a data center. In this sense, the customer funds repository functions much like a data center in known prior art postage download systems.

One advantage of the system 5 and the methods shown in FIGS. 2 and 3 is that they do not require the postage meters 20 or the data center server computer 40 and secure coprocessor 45 to be significantly altered. Specifically, each is able to continue to use the stored meter encryption and meter signing keys that would be used in the case of operation of a prior art postage download system.

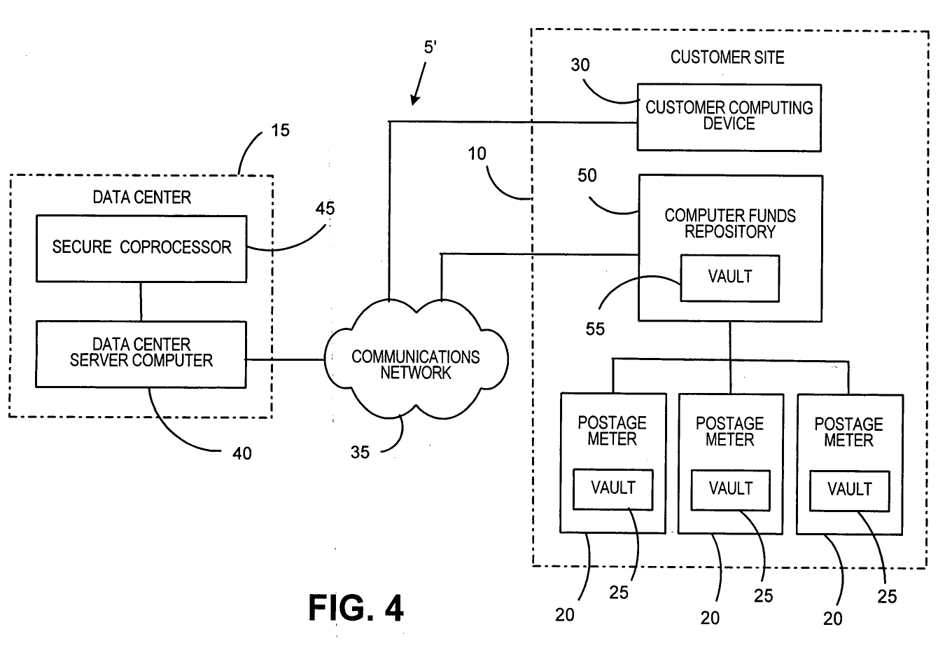

FIG. 4 is a block diagram of a system 5′ for managing postage funds for use by multiple postage meters located at a customer site according to an alternative embodiment of the present invention. The system 5′ shown in FIG. 4 is similar to the system 5 shown in FIG. 1 in all respects except that in the system 5′ the customer funds repository 50 is located at the customer site 10 as opposed to being located at the data center 15 as is the case with the system 5 of FIG. 1. Operation of the system 5′ is nearly identical to that of system 5 such that the system 5′ allows postage to be stored in the customer funds repository 50 in the manner shown in FIG. 2 and allows postage funds to be selectively downloaded to postage meters 20 in the manner shown in FIG. 3. The only significant difference is that in the system 5′, communication between the customer funds repository 50 and the data center sever computer 40 takes place over the communications network 35. All the embodiments shown are capable of supporting the direct and secure transfer of funds between two separate postage meters.

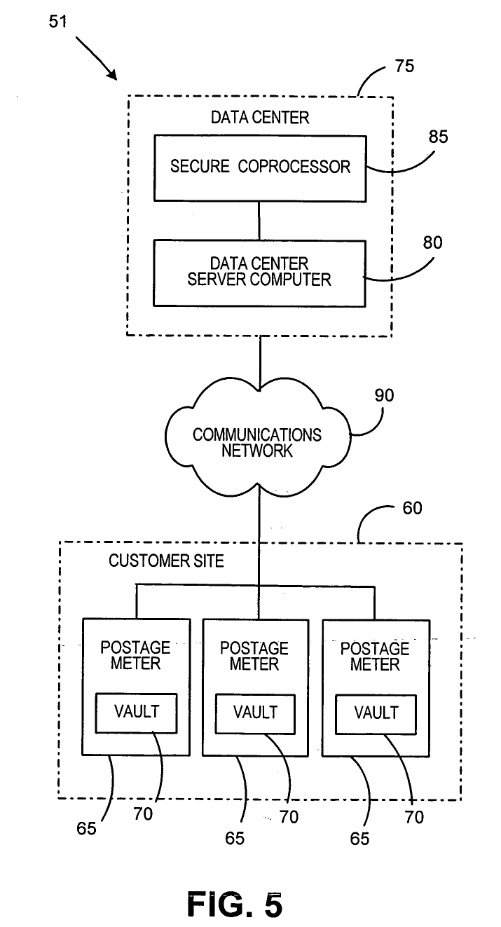

FIG. 5 is a block diagram of a system 51 for managing postage funds for use by multiple postage meters located at a customer site according to a further alternative embodiment of the present invention in which postage funds may be directly and securely transferred between the postage meters (referred to herein as a “side load” transaction). As seen in FIG. 5, the system 51 includes customer site 60 that includes a plurality of postage meters 65 (three are shown, but more or less may also be provided) each having a vault 70. The postage meters 65 and the vaults 70 are similar to the postage meters 20 and vaults 25 shown in FIG. 1. The system 51 also includes a data center 75 that includes a data center server computer 80 and a secure coprocessor 85, which are similar to the data center server computer 40 and secure coprocessor 45 shown in FIG. 1. A communications network 90, similar to communications network 35 of FIG. 1, is provided to enable the data center server computer 80 to communicate with each of the postage meters 65. As mentioned above, according to an aspect of the present invention, postage funds downloaded from the data center 75 and stored in the vault 70 of one of the postage meters 65 may be transferred to and stored in the vault 70 of another one of the postage meters 65 for use by that postage meter 65 in applying evidence of postage payment to items to be mailed. In order to perform a side load transaction, the postage meters 65 are in electronic communication with one another through, for example, the communications network 90, or a wired connection or a short range wireless connection such as a through a Bluetooth network, a Zigbee network, or another RF wireless network.

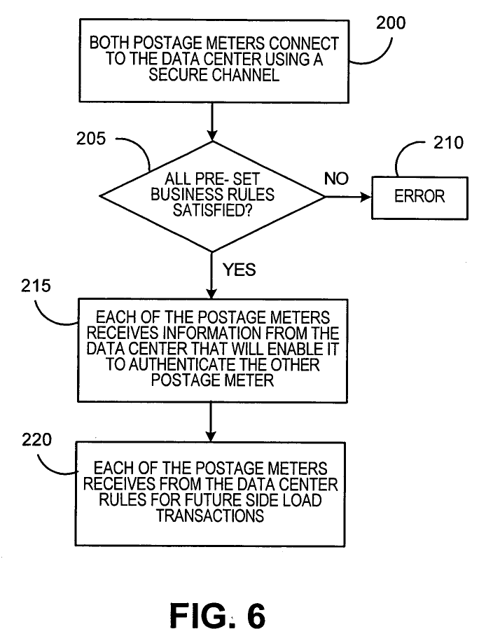

FIG. 6 is a flowchart of a setup process according to the present invention that must be performed before a side load transaction between two postage meters 65 may take place. The setup process begins at step 200, where the two postage meters 65 connect to the data center server computer 80 through communications network 90 using a secure communications channel. The two postage meters 65 may connect to the data center at the same time or at different times. Preferably, the secure communications channel that is used is an SSL (Secure Socket Layer) connection, although other types of secure channels that provide mutual authentication and data privacy may also be used. Next, at step 205, the data center server computer 80 determines whether all of the pre-set business rules for side load transactions have been satisfied. The pre-set business rules consist of one or more conditions that must exist in order for the two postage meters 65 in question to be permitted to engage in side load transactions. In the preferred embodiment, the pre-set business rules include a requirement that each of the postage meters 65 in question belong to the same customer and/or a requirement that each of the postage meters 65 in question be located in the same USPS financial district. If the answer at step 205 is no, then, as shown in step 210, an error condition is detected, and the two postage meters 65 will not be permitted to engage in side load transactions with one another. If, however, the answer at step 205 is yes, then, at step 215, the data center server computer 80 sends to both of the postage meters 65 all information that is necessary to enable the two postage meters 65 to mutually authenticate one another. In particular, the information received by each postage meter 65 includes the meter ID and the public keys of the other postage meter 65. The public keys consist of a first public key that corresponds to the private key used by the other postage meter 65 during the establishment of a secure channel as described below, and a second public key that corresponds to the private key used by the other postage meter 65 to digitally sign data. Finally, at step 220, each of the postage meters 65 receives a set of businesses rules that govern future side load transactions between the two postage meters 65. For example, those business rules may specify the maximum amount of funds that may be transferred from one postage meter 65 (the sending meter) to the other postage meter 65 (the receiving meter) in one or more transactions, the number of transactions that may be used to transfer the specified maximum amount (e.g., only one transaction, or five separate transaction), and/or the time period within which the specified maximum amount must be transferred and the some or all of the specified number of transactions must be completed.

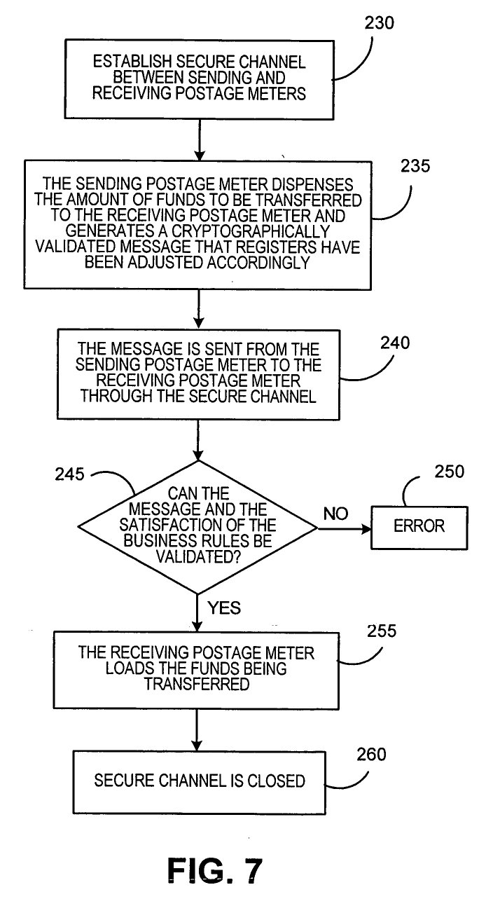

FIG. 7 is a flowchart showing a method for conducting side load truncations between two postage meters 65 (a sending postage meter 65 and a receiving postage meter 65) according to an aspect of the present invention. As will be appreciated, prior to the steps shown in FIG. 7, the sending postage meter 65 and the receiving postage meter 65 must have gone through the setup process shown in FIG. 6.

The method of FIG. 7 begins at step 230, wherein a secure communications channel is established between the sending postage meter 65 and the receiving postage meter 65. Preferably, the secure communications channel that is used is an SSL (Secure Socket Layer) connection, although other types of secure channels that provide mutual authentication and data privacy may also be used. In establishing the secure communications channel, the sending postage meter 65 and the receiving postage meter 65 each use the public key that was received in step 215 of the setup process to authenticate the other. Next, at step 235, the sending postage meter 65 dispenses the amount of funds to be transferred to the receiving postage meter in the side load transaction and generates a cryptographically validated message that confirms that the registers of the sending postage meter 65 have been updated accordingly. In the preferred embodiment, the cryptographically validated message consists of a postal indicium, for a predefined ZIP code not used by the USPS, generated by the sending postage meter 65 that is in the amount of the funds to be transferred. Then, at step 240, the cryptographically validated message, preferably the indicium, is sent to the receiving postage meter 65 over the secure communications channel. Preferably, the sending postage meter 65 digitally signs the cryptographically validated message before it is sent to the receiving postage meter 65. When the cryptographically validated message is received, the receiving postage meter 65, at step 245, determines whether the cryptographically validated message can be validated (using the appropriate public key received in step 215 of the setup process) and whether the business rules have been satisfied (e.g., has maximum amount or number of transaction been exceeded or has the predetermined time period expired). If the answer is no, then, at step 250, an error condition is detected and the side load transaction is not permitted to continue. If, however, the answer is yes, then, at step 255, the receiving postage meter 65 loads the transferred funds by incrementing its descending register by the appropriate amount (in the preferred embodiment, the descending register is incremented by the amount of the received indicium). In addition, in the preferred embodiment, the receiving postage meter 65 stores the received indicium for future audit purposes. As shown in step 260, the secure channel is then closed.

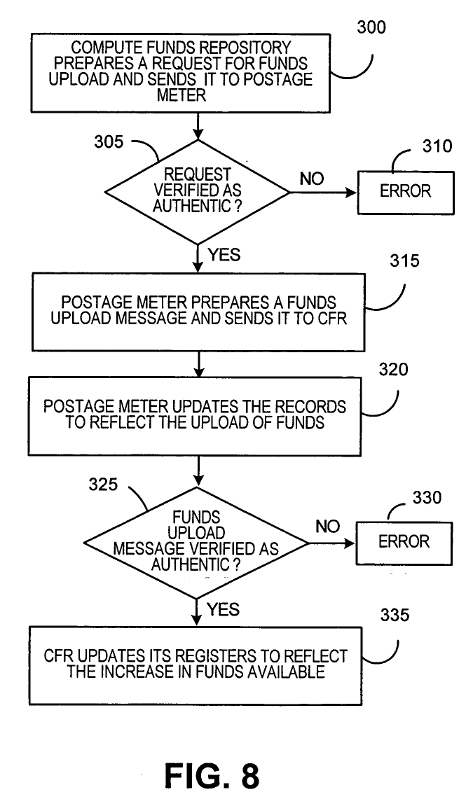

FIG. 8 is a flowchart showing a method by which the postage funds stored by a postage meter 20 may be uploaded to CFR 50 according to a further aspect of the present invention so that those funds may used by CFR 50 to redistribute the funds to one or more other postage meters. The method begins at step 300, where the CFR 50 prepares a request for funds upload (for a particular amount of postage) and sends it to the postage meter 20 over communications network 35. Preferably, the request for funds upload is encrypted for security purposes. In the particular embodiment shown in FIG. 1, the request for funds download is encrypted using the unique meter encryption key for the CFR 50 and digitally signed using the unique meter signing key for the CFR 50.

Once the request for funds upload is received by the postage meter 20, it then, as shown in step 305, determines whether the request for funds download can be verified as being authentic. In the embodiment of FIG. 1, the postage meter does so by decrypting the request for funds upload using the unique meter encryption key for the CFR 50 in question that is stored in the vault 25 and verifying the digital signature using the unique meter signing key for the CFR 50 that is stored in the vault 25. If the answer at step 305 is no, then an error condition is detected and the request will not be fulfilled. If, however, the answer at step 305 is yes, then, in step 315, the postage meter 20 accesses the postage fund data from the vault 25, prepares a funds upload message including data representing the requested amount of postage (if the full amount is available), and sends the funds upload message to the CFR 50 in question over the communications network 35. Preferably, the funds upload message is encrypted and digitally singed for security purposes. In the particular embodiment of FIG. 1, the funds download message is encrypted using the unique meter encryption key for the CFR 50 and digitally signed using the unique meter signing key for the CFR 50. Next, at step 320, the postage meter 20 updates its records (the data stored in vault 25) to reflect the amount of postage funds that were uploaded.

At step 325, the CFR 50 then determines whether the funds upload message can be verified as being authentic. In the particular embodiment of FIG. 1, the CFR 50 does this by decrypting the funds upload message and verifies the digital signature. If the answer at step 325 is no, then an error condition is detected, and the CFR 50 will not accept and store the upload of funds. If the answer at step 325 is yes, then, at step 335, the CFR 50 updates its registers (in its vault 55) to reflect the increase in postage funds that are available for use. Thus, as will be appreciated, using the method of FIG. 8, a postage meter 20 is able to readily upload postage funds as needed to the customer funds repository 50 without having to go through all of the formal steps required in prior art systems to withdraw postage from a postage meter.

According to a further aspect of the present invention, whenever each of the postage meters 65 connects to the data center server computer 80, for example for a normal postage download and or an audit, the postage meter 65 uploads data, including transfer amounts, relating to all side load transactions that the postage meter 65 has been involved in (as the sending or receiving meter) since the last communication with the data center server computer 80. As will be appreciated, this upload of data is necessary to allow correct operation of the postage download algorithms run by the data center server computer 80.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A system for managing postage funds, comprising:
a data center computer system for authorizing and accounting for postage fund downloads for one or more customers;
a customer funds repository in electronic communication with said data center computer system, wherein said customer fund repository is adapted to send a request for a first amount of postage funds to said data center computer system and to receive and store said first amount of postage funds downloaded from said data center computer system; and
a plurality of postage meters located at a customer site remote from said data center computer system, said postage meters being in electronic communication with said customer funds repository, wherein each of said postage meters is adapted to selectively send a request for a second amount of postage funds to said customer funds repository and to receive and store said second amount of postage funds downloaded from said customer funds repository.

2. The system according to claim 1, wherein said customer funds repository and said data center computer system are provided at a data center location remote from said customer site.

3. The system according to claim 1, wherein said customer funds repository is provided at said customer site.

4. The system according to claim 1, wherein said data center computer system and said customer funds repository each store a first set of one or more keys, said first set of one or more keys being used to securely send said request for a first amount of postage funds to said data center computer system and to securely download said first amount of postage funds from said data center computer system.

5. The system according to claim 1, wherein each of said postage meters stores a second set of one or more keys, wherein said customer funds repository stores the second set of one or more keys of each of said postage meters, and wherein for each one of said postage meters, the second set of one or more keys of said one of said postage meters is used to securely send the request for a second amount of postage funds to said customer funds repository and to securely download the second amount of postage funds from said customer funds repository to said one of said postage meters.

6. The system according to claim 1, further comprising a computing device located at said customer site, said computing selectively causing said customer fund repository to send said request for a first amount of postage funds to said data center server computer system.

7. A method of transferring a first amount of postage funds from a first postage meter to a second postage meter, comprising:
establishing a secure communications channel between said first postage meter and said second postage meter;
causing said first postage meter to dispense said first amount of postage funds and generate a message that confirms that one or more registers of said first postage meter have been adjusted to reflect that said first amount of postage funds has been dispensed;
sending said message to said second postage meter through said secure communications channel; and
causing said second postage meter to load said first amount of postage funds.

8. The method according to claim 7, wherein said message is a cryptographically validated message.

9. The method according to claim 8, wherein said message is a postal indicium created by said first postage meter in an amount equal to said first amount of postage funds.

10. The method according to claim 9, wherein said indicium is for a zip code not used by the postal service.

11. The method according to claim 8, further comprising determining whether said message can be validated, wherein said step of causing said second postage meter to load said first amount of postage funds is performed only if said message can be validated.

12. The method according to claim 7, further comprising determining whether one or more business rules governing a transfer of postage funds from said first postage meter to said second postage meter are satisfied, wherein said step of causing said second postage meter to load said first amount of postage funds is performed only if said one or more business rules are determined to be satisfied.

13. The method according to claim 12, wherein said one or more business rules relate to one or more of a maximum amount of postage funds that may be transferred from said first postage meter to said second postage meter, a maximum number of times that postage funds may be transferred from said first postage meter to said second postage meter, and a time period during which postage funds may be transferred from said first postage meter to said second postage meter.

14. The method according to claim 7, wherein before said step of establishing a secure communications channel between said first postage meter and said second postage meter, the method further comprises:
causing said first postage meter to connect to a data center over a second secure communications channel and said second postage meter to connect to said data center over a third secure communications channel;
providing first information to said first postage meter over said second secure communications channel, said first information enabling said first postage meter to authenticate said second postage meter; and
providing second information to said second postage meter over said third secure communications channel, said second information enabling said second postage meter to authenticate said first postage meter.

15. The method according to claim 14, wherein said first information and said second information are used in said step of establishing a secure communications channel between said first postage meter and said second postage meter.

16. The method according to claim 11, wherein before said step of establishing a secure communications channel between said first postage meter and said second postage meter, the method further comprises:
causing said first postage meter to connect to a data center over a second secure communications channel and said second postage meter to connect to said data center over a third secure communications channel;
providing first information to said first postage meter over said second secure communications channel, said first information enabling said first postage meter to authenticate said second postage meter; and
providing second information to said second postage meter over said third secure communications channel, said second information enabling said second postage meter to authenticate said first postage meter;
wherein said second information is used in said step of determining whether said message can be validated.

17. The method according to claim 12, wherein before said step of establishing a secure communications channel between said first postage meter and said second postage meter, the method further comprises:
causing said first postage meter to connect to a data center over a second secure communications channel and said second postage meter to connect to said data center over a third secure communications channel;
providing first information and said business rules to said first postage meter over said second secure communications channel, said first information enabling said first postage meter to authenticate said second postage meter; and
providing second information and said business rules to said second postage meter over said third secure communications channel, said second information enabling said second postage meter to authenticate said first postage meter.

18. The method according to claim 14, further comprising determining whether all of one or more business rules have been satisfied, wherein said proving steps are performed only if it is determined that all of the one or more business rules have been satisfied.

19. The method according to claim 18, wherein said one or more business rules include one or both of a rule that said first and second postage meters belong to the same party and a rule that all of one or more business rules have been satisfied be located in the same financial district.

20. A system for managing postage funds, comprising:
a data center computer system for authorizing and accounting for postage fund downloads for one or more customers;
a customer funds repository in electronic communication with said data center computer system, wherein said customer fund repository is adapted to send a request for a first amount of postage funds to said data center computer system and to receive and store said first amount of postage funds downloaded from said data center computer system; and
a plurality of postage meters located at a customer site remote from said data center computer system, said postage meters being in electronic communication with said customer funds repository, wherein each of said postage meters is adapted to selectively send a request for a second amount of postage funds to said customer funds repository and to receive and return said second amount of postage funds downloaded from said customer funds repository.
